(19) United States
(12) Patent Application Publication
(10) Pub. No.: US 2003/0088496 A1
(43) Pub. Date: May 8, 2003

(54) Tag processing terminal for facilitating competitive internet bid transactions

(75) Inventor: Daniel J. Piotrowski, Edison, NJ (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/003,050

(22) Filed: Nov. 2, 2001

(51) Int. Cl. G06F 17/60

(52) U.S. Cl. 705/37

(57) ABSTRACT

An Internet enabled remote tag-processing terminal is disclosed for facilitating commercial transactions using competitive information. A remote terminal reads/scans product tags or labels, and their content is transmitted to a service node to conduct an on-line search for competitive information on similar products. The service node then sends an information response to the remote terminal, which allow a user (1) to determine whether to complete a commercial transaction while in a retailer location, (2) complete an on-line commercial transaction in response to the received competitive information or (3) adjust the scanned tag or search parameters to conduct a new search.

### FIELD OF THE INVENTION

The present invention relates generally to the field of electronic devices, and more particularly to a system and method improving processing and enhancing performance of an information oriented device using information tags and a communication network for facilitating competitive Internet bid transactions.

### BACKGROUND OF THE INVENTION

Electronic commerce and information retrieval are two of the most important aspects of the Internet or World Wide Web. As the Internet grows, many Web sites are becoming connected and more corporations are do business on the “Web”. Moreover, these Web sites are providing an increasing amount of information regarding almost any product available in traditional retail stores, as well selling their products electronically.

This e-commerce ability allows users, almost anywhere on the globe to which a Web connection is available, to access any commercial business offering catalog implemented as a Web site.

As with prior forms of traditional commerce, consumers are quickly becoming savvier in their use of the Internet (e.g. e-commerce) to retrieve product information, purchase various items and obtain the best on-line deals.

In particular, the Internet has provided a convenient mechanism for marketing products. Many web sites offer products for sale. Generally a potential customer viewing such a web site indicates a desire to buy a particular product by “clicking” on a particular location on the display screen. Some sites require a user to “register” by giving a name, address and credit card information. Later when a customer desires to buy a product the information entered during registration is used for billing and shipping. Other sites allow a customer to enter billing and shipping information after the customer has indicated a desire to purchase a particular product.

Some web sites allow a buyer to bid on products that are offered in the Internet's equivalent of an auction. Other web sites allow a user to made an offer to buy products at a price specified by the buyer, much as an individual might make an offer to buy a product at a particular price in a face to face situation.

Web sites such as those described above in essence utilize the Internet to automate a conventional buying process. The process takes place at great speed and the parties may be remote, but the fundamental transaction is conventional. Moreover, e-commerce users lack an effective interface when using the Internet remotely. Although, certain remote hand-held devices are known interfacing with the Internet, such as PDAs and Internet enabled cell phones, they all suffer limitations such as difficulty in inputting a large amount of data quickly, or curtailed Internet capability. More importantly, consumers lack the ability to efficiently merge the use of on-line capabilities (e.g. e-commerce) in a real-time manner, while in a traditional place of commerce (e.g. on-site).

### SUMMARY OF THE INVENTION

The invention provides a remote tag processing terminal for facilitating competitive Internet bid transactions and counter offer proposals. A remote terminal reads/scans one or more item/product tags or labels, and their content is transmitted to a service node. The service node enables on-line retailers to evaluate the scanned labels and send competitive bid information for related products to the remote terminal. This allows a user to determine whether to complete an on-line or on-site commercial transaction in response to the received competitive bids from other retailer or submit a counter offer for a particular product to one or more (on-line or on-site) retailers.

One embodiment of the invention is directed to a method of doing business that allows a remote user to receive competitive bids for similar products relating to a scanned product tag or label in a retailer location, which can then be accepted to complete an on-line transaction. Remote users/customers obtain competitive bids from one or more on-line retailers of similar products available through the Internet, while shopping in a conventional mall or retailer location. A customer uses a remote terminal that is configured with a scanner, to scan the item or product. The remote terminal scans the barcode or electronic identification, such as radio frequency identification (RFID) of a merchandise item. The remote terminal includes a display screen and a wireless communication capability for transmitting this information to a service node, such as a network server or host computer. Thereafter, the service node enables on-line retailers the opportunity to send competitive bids on similar products available on their Web site or actual location, e.g. a Macy's or Wal-Mart location, to the mobile terminal. The user can then select which product to purchase, e.g. an on-line product or the on-site.

Another embodiment of the invention is directed to an apparatus including a tag reader capable of reading information from one or more product tags, a communication unit capable of communicating information to one or more service nodes and a controller arranged to receive information from the label reader, send a request to one or more of the service nodes through the communication unit, receive/display a response from the service node, and send profile information, regarding a user, to a service node to accept a competitive bid or send a counter offer in response to one or more of the received competitive bids and then enter into a commercial transaction with the on-line retailer. The request and the response are formatted as documents capable of being exchanged in a distributed, decentralized environment.

### BRIEF DESCRIPTION OF THE DRAWING

These and other advantages and features of the invention will become more apparent from the following description of an illustrative embodiment of the invention considered together with the drawings, in which:

FIG. 1 illustrates the operation of a tag processing system for facilitating competitive Internet bid transactions in accordance with the invention.

FIG. 2 is a block diagram of an exemplary remote terminal device in accordance with one embodiment of the invention.

FIG. 3 is a block diagram of exemplary communication stacks for a remote terminal in accordance with one embodiment of the invention.

### DETAILED DESCRIPTION

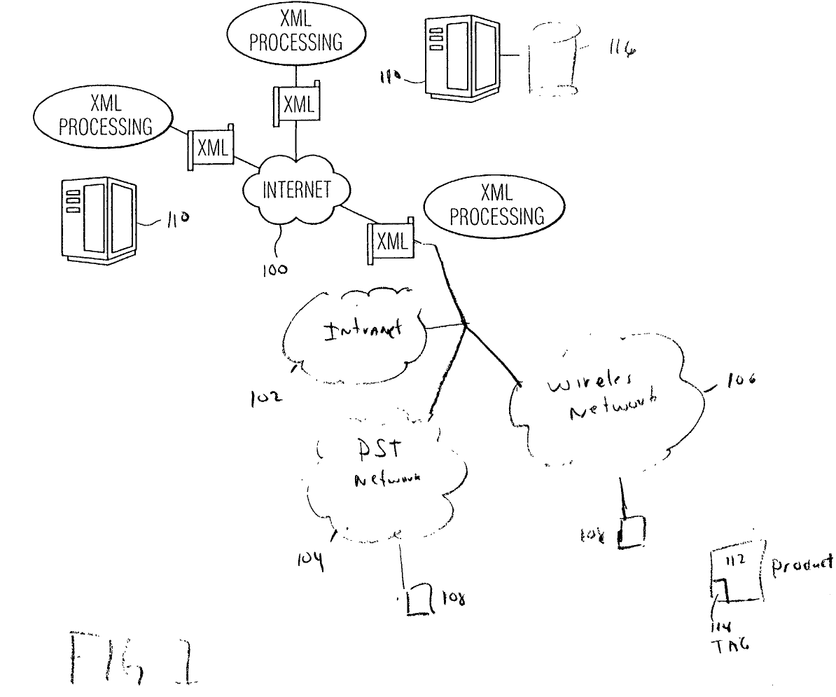

FIG. 1 shows a system for facilitating competitive Internet bid transactions using product information received from a tag processing remote terminal. The system utilizes electronic tag technology, such as barcode technology or Radio frequency identification (RFID) technology, which allows product tags or labels to be read and their content to be transmitted to a web site or Internet service provider to enable on-line retailers to conduct a search for similar products in their catalog or inventory and provide a competitive bid to the service node/web site. The service node/web site then sends a response to the terminal, which allows a user to accept one or more of the competitive bids.

The system includes the following components: interconnected service provider networks, including the Internet 100, an Intranet 102, a Public Switched Telephone Network 104, and a wireless network 106, wireless remote terminals 108, and service nodes 110. It will be recognized that FIG. 1 is simplified for explanation purposes and that the full network environment for the invention will comprise provisions for network reliability through redundancy, links to other networks and applications, etc., all of which need not be shown here.

Smart labeling is the latest Radio frequency identification (RFID) technology, combining the advantages of barcode, Electronic Article Surveillance (EAS) and traditional RFID solutions. RFID systems allow for non-contact reading in manufacturing and other types of environments where barcode labels may not perform properly or be practical. RFID has applications in a wide range of markets including automated vehicle identification (AVI) systems and livestock identification because of its capability to track moving objects. The technology has become a primary player in identification, automated data collection, and analysis systems worldwide.

For example, Philips Semiconductors' ICODE ICs represent the state-of-the-art in smart label technology, offering a low-cost, re-programmable and disposable solution for source tagging, automatic data capture, theft protection and data storage on a product or its packaging. ICODE smart labels allow almost any item to be tagged for efficient handling. ICODE's highly automated item scanning process does not require line-of-sight and can scan multiple labels at the same time.

As shown in FIG. 1 one or more remote terminals 108 scan a particular product 112 tag or label 114. Preferably, the tag or label 114 comprises an RFID tag, but other types of information tags may be used, e.g., barcodes. The remote terminal 108 communicates with one or more of the more service nodes 110, over the service provider networks, e.g. network servers, Internet service provider (ISP) nodes, Intranet LAN, Websites, etc. For example, the Internet may be accessed by the remote terminal 108 through a wireless interface connection, using well-known conventional communication protocols such as the Internet Protocol (IP).

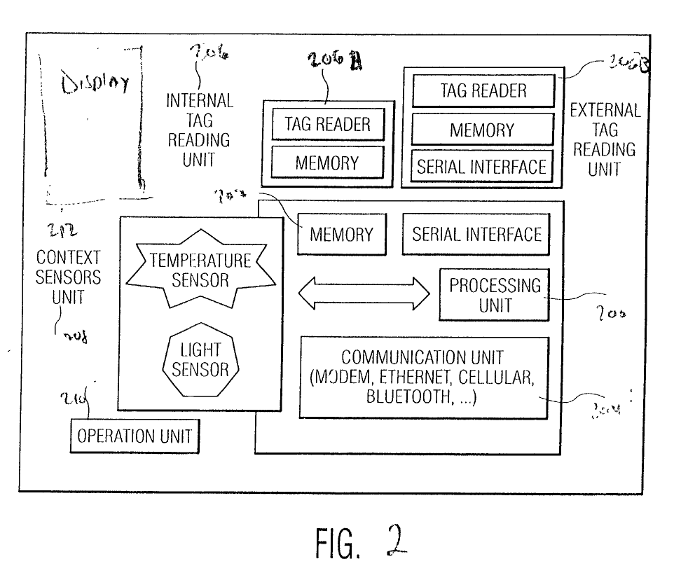

FIG. 2 shows an example of a hardware design of the remote terminal 108 in accordance with one embodiment of the invention. In this example, the remote terminal 109 includes a processor 200, a memory 202 and a display . The processor 200 may represent, e.g., a microprocessor, a central processing unit, a computer, a circuit card, an application-specific integrated circuit (ASICs), as well as portions or combinations of these and other types of processing device which already part of the remote terminal 108 (e.g., CPU for a wireless handset or PDA). The memory 202 may represent, e.g., disk-based optical or magnetic storage units, electronic memories, as well as portions or combinations of these and other memory devices. The display 121 may represent a video, audio, or tactile means of communicating information. As shown, the remote terminal 108 also includes a communication unit 204 (e.g. Ethernet, Bluetooth, cellular or packet data interface), a tag reading unit 206, and one or more context sensors 208. The tag reading unit 206 may be internal to the remote terminal 100 in which the unit 206A appears as part of the memory space of the remote terminal 108 or an external reading unit 206B that can be accessed via a serial interface. Preferably, the tag reading unit 206 is an RFID type reader, but other types of tag/identity generation/reading mechanisms may be used, e.g., a barcode reader. The context sensors 208 may include any type of sensor necessary or useful for the specific remote terminal 108 (e.g., temperature sensors, light sensors, moisture sensors, motion sensors, infrared sensors, etc.).

The remote terminal 108 may also include one or more operation units 210. The operation unit 210 performs the functions of a secondary task unrelated to the principles of the present invention, such as the operation of a wristwatch, personal computer, PDA or wireless telephone. Importantly, an operation unit is needed, such as a keyboard or a tactile interface, such as a stylus and a video display, to adjust the received competitive bid information to transmit a counter offer to one or more service nodes, as described below. It should be understood that these are only examples and the remote terminal 108 is not to be limited by these examples.

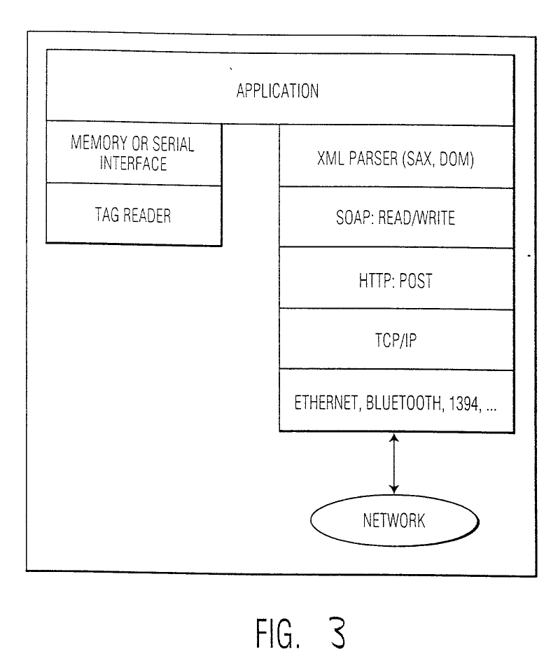

The software design for the communication stacks of the remote terminal 108 are illustrated in the embodiment of FIG. 3. These stacks may include: Physical and data link layers: Ethernet, Bluetooth, 1394, or other similar protocols; Network and transport layers: IP and TCP protocols; HTTP protocol: Post feature only; Simple Object Access Protocol (SOAP): read/write capabilities only; XML parser using Document Object Model (DOM) or Simple API for XML (SAX) interfaces. Preferably a micro XML parser (less than 40 KB in size) is used as described in U.S. patent application Ser. No. 09/725,970, filed Nov. 29, 2000, incorporated herein by reference; Memory or serial interface to tag reader.

Additional details regarding conventional XML may be found in XML 1.0 (Second Edition), World Wide Web Consortium (W3C) Recommendation, October 2000, www.w3.org/TR/REC-xml, which is incorporated by reference herein.

As referenced in FIG. 3, SOAP is a protocol for exchanging information in a distributed, decentralized environment. SOAP is an XML based protocol consisting of: an envelope which defines a means for describing what a message contains and how it is to be processed, encoding rules for expressing application-defined datatypes, and a convention for representing remote procedure calls and responses. SOAP messages are typically one-way transmissions from a sender to a receiver, but they can be combined to implement patterns such as request/response.

HTTP is a protocol with the lightness and speed necessary for a distributed collaborative hypermedia information system. It is a generic stateless object-oriented protocol, which may be used for many similar tasks such as name servers, and distributed object-oriented systems, by extending the commands, or “methods”, used. A feature if HTTP is the negotiation of data representation, allowing systems to be built independently of the development of new advanced representations.

In general, sending data over the Internet is typically performed using Transmission Control Protocol/Internet Protocol (TCP/IP).

The physical layer is concerned with the electrical, mechanical and timing aspects of signal transmission over a communication medium. The remote terminal 100 can include any one or more of a variety of well known layers such as modems, Ethernet, cellular and Bluetooth.

Returning now to FIG. 1, in operation, the remote terminal 108 receives/reads information the label 114. The label 114 may be active or passive. A determination is made as to which of the service nodes 110 is to be contacted. This determination is based upon information received/read from the label 114. For example, the type of product scanned is used to determine the service nodes, e.g. a scanned television product would send the label information to television manufacture/distributor (service nodes) web sites. Moreover, the service nodes 110 may be a web server of for a particular search engine or a product's (or similar product's) manufacturer. Tables of product/manufactures can be used facilitate this determination. The remote terminal 108 then sends a document containing tag information to one or more of the more determined service nodes 110. The remote terminal 108 then receives one or more competitive bids from one or more on-line retailers back from the service nodes 110. In this example the competitive bids include pricing and shipping cost, of similar products available through the Internet. Thereafter, a user can accept a particular competitive bid received, or submit a counter offer to a particular on-line retailer.

In this manner a user is able to remotely whether to complete an on-site or an on-line sales transaction or make a counter offer to either the on-site or an on-line retailer. Remote users/customers obtain competitive bids, while shopping in a conventional mall or retailer location.

An advantage of the present invention is that a wide variety of system architectures can be used to implement the system of FIG. 2. Server-side and client-side architectures can be used. As briefly mention above, the service nodes 114 may be a web server coupled to the remote terminal 100 over the Internet or other communication network.

As shown in FIG. 1, the service nodes 110 may be coupled to a profile database 116. It is noted that the profile database 116 may be integrated with the service nodes 110. The service node 114 processes the document from the remote terminal 108 and accesses an appropriate profile from the profile database 116. The profiles represent information associated with particular user for the remote terminal 108. One or more profiles may be associated with a particular remote terminal 108 for different users. Each profile includes information necessary to complete commercial transaction on-line, e.g. credit card information, mailing address. They may also contain user preferences as provided by each user, regarding products, such as made, models, etc. or as determined by the remote terminal 100 using historical information indicative of previous product requests (e.g. product tags scanned) between a remote terminal and the service node.

Alternatively, the remote terminal 108 may initially contact a first service node 110 which includes an index/directory of other service nodes 110.

Preferably an XML/SOAP message is sent and received by the remote terminal 108 and the service nodes 110. This is advantageous because messages can be exchanged efficiently in a distributed, decentralized environment. The XML/SOAP message can be adapted to many different applications.

The HTTP Post Module was designed to offer the posting mechanism needed by the remote terminal 108. Since a full implementation of the HTTP 1.1 specification was not necessary for this module, it only implements the HTTP POST command. The module may be built using the win-socket library (WinSock32.11b) available with Microsoft Visual Studio V: 6.0.

The SOAP Write Module may be created using WriteSOAP. WriteSOAP is a module for creating SOAP messages compliant with the SOAP specifications. See SOAP: Simple Object Access Protocol Version 1.1 (www.w3.org/TR/SOAP/), which is incorporated by reference herein. Another requirement for module is to create SOAP messages that can be understood by the APACHE-SOAP implementation. This is a very versatile tool for writing XML documents. It is able to make a direct mapping between various data-types and their equivalent representation in SOAP.

The functional operations associated with the remote terminal 108, as described above, may be implemented in whole or in part in one or more software programs stored in the memory 202 and executed by the processor 200. Additionally, the service provider networks of FIG. 1 may also represent a wide area network, a metropolitan area network, a local area network, a cable network or a satellite network, as well as portions or combinations of these and other types of networks. The service nodes 110 and the remote terminals 108 may themselves be respective server and client machines coupled to the service provider networks.

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, and the like represent various processes which may be substantially represented in computer readable medium and so executed by a computer or processor, whether or not such computer or processor is explicitly shown.

The functions of the various elements shown in the FIGS. 1 and 2, including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

What is claimed is:

1. A wireless remote terminal apparatus comprising:
a label reader capable of reading information from a label, wherein the label is associated with a first product;
a communication unit capable of communicating information to one or more service nodes; and
a controller, coupled the label reader, the communication unit, arranged to receive information from the label reader, send a request to one or more of the service nodes through the communication unit, receive at least one competitive bid from an on-line retailer in response to the request from the service node, wherein the competitive bid relates to an on-line retailer's product similar to the first product and wherein the request and the competitive bid are formatted as documents capable of being exchanged in a distributed, decentralized environment.

2. The apparatus according to claim 1, wherein, responsive to the received competitive bid, the controller is further arranged to allow a user to adjust the received competitive bid and send a counter offer to one or more of the service nodes.

3. The apparatus according to claim 1, wherein, responsive to the received competitive bid, the controller is further arranged to allow profile information to be accessed by a service node to accept a selected competitive bid and engage in an on-line transaction.

4. The apparatus according to claim 1, wherein the apparatus and the service node communicate in a client/server network.

5. The apparatus according to claim 4, wherein the documents comprise XML documents.

6. The apparatus according to claim 5, wherein the XML documents are expressed as SOAP messages.

7. The apparatus according to claim 1, further comprising a context sensor coupled to the controller.

8. The apparatus according to claim 1, wherein the one or more service nodes are responsive to a profile associated with a user contained within the request from the apparatus.

9. The apparatus according to claim 1, wherein the label reader comprises an RFID reader or a barcode reader.

10. An wireless remote terminal apparatus comprising:
a memory; and
a processor coupled to the memory and operative to read an item's tag information, communicate the tag information to a service node, receive a competitive bid from the service node, and responsive to the received response, to allow profile information to be accessed by a service node to engage into a commercial transaction, and where the request and the response are formatted as documents capable of being exchanged in a distributed, decentralized environment.

11. The apparatus according to claim 12, wherein the tag comprises an RFID or barcode tag.

12. A method for allowing a remote user to receive competitive bids for products similar to that of a first product, the method comprising the steps of:
reading label information from a first product, the product located at a retailer location, using a remote terminal;
communicating the information to one or more service nodes using the remote terminal;
searching, using the label information from the first product, one or more other retailers' information for similar products;
forming a competitive bid proposal for the similar products by at least one other retailers; and
transmitting the competitive bid proposal to the wireless remote terminal.

13. The method according to claim 12, further including accepting the competitive bid proposal.

14. The method according to claim 12, further including transmitting, by the remote terminal, a counter offer in response to at least one competitive bid proposal to the service node.

15. The method according to claim 12, wherein the one or more service nodes are responsive to a profile associated with a user contained within the information from the remote terminal.
